(19) United States
(12) Patent Application Publication
(10) Pub. No.: US 2003/0154950 A1
(43) Pub. Date: Aug. 21, 2003

(54) Device for noise and temperature insulation of an exhaust gas outlet on a portable engine powered tool

(76) Inventor: Gustaf Doragrip, Jonkoping (SE)

Correspondence Address: PEARNE & GORDON LLP, 526 SUPERIOR AVENUE EAST, SUITE 1200, CLEVELAND, OH, 44114-1484, US

(21) Appl. No.: 10/257,606

(22) PCT Filed: Feb. 12, 2002
(86) PCT No.: PCT/SE02/00242

(51) Int. Cl. F02B 77/00

(52) U.S. Cl. 123/198 E

(57) ABSTRACT

The claimed invention illustrates a solution that will make it possible to lead exhaust gas from a combustion engine (10) through a noise insulating cover (11) without reducing the noise insulating effect of the cover (11). This is possible by leading the exhaust gas through an expansion chamber (15) made of a material that insulates the cover (11) from the high temperature exhaust gas. The expansion chamber (15) is shaped so that the exhaust gas is lead through a curved channel in order to prevent the noise from spreading outside the cover (11).

Portable tools driven by a combustion engine are widely and increasingly used for different kind of work in the countryside in order to facilitate and make the work more efficient. There are several different types of tools for this kind of work, for example hedge trimmers and leaf blowers. One thing these combustion engine driven tools have in common is that they generate a high level of noise that will affect both human beings and animals in the surrounding area in a negative way. The noise that is generated from the tool is also one important parameter that effects the working condition for the operator that is exposed to the noise during use of the tool.

The noise generated from this kind of tools spring form different sources in the tool. In for example a leaf blower is a big part of the total amount of noise related to the engine-powered fan and of course from the engine. Other types of tools may have other components that generate a high level of noise. In all engine-powered tools does the engine cause a not negligible amount of the generated noise.

One solution in order to reduce the noise from the tool is to provide the engine and the other noise generating components with a cover that insulates the noise from spreading to the environment. This type of cover must be made of a material suitable for noise insulation and also light so that the weight of the tool could be kept low and the use of the tool easy for the operator. These types of covers are normally made of some sort of plastic material that has a low weight and is easy make in the desired shape in order to fit the tool. Unfortunately are plastic materials normally very sensitive to high temperatures and could therefore be damaged by the high temperature exhaust gas.

The exhaust gas from the combustion engine has a high temperature when they leave the engine and must solely be lead out though the cover without melting or damaging the cover. The exhaust gases must also be lead out through the cover without reducing the insulating of the noise generated by the engine and other components located inside the cover. This patent application presents an efficient solution to the problem described earlier in this text.

In order not to damage the cover of the tool by the high temperature exhaust gas is an expansion chamber integrated in the cover. The expansion chamber could be placed differently in the cover depending on type of tool and where the components inside the cover are placed. The expansion chamber is made of a suitable material that has good insulating features for high temperatures so that the cover not will be damaged by the exhaust gases. The material in the expansion chamber must also have a feature that makes the expansion chamber efficient in the insulation of noise. The expansion chamber is shaped so that the exhaust gas will pass through a curved chamber that will stop the sound waves from passing out through the expansion chamber together with the exhaust gas. In the attached drawings is the exhaust gas lead through an S-shaped expansion chamber in order to provide good noise insulation.

The inlet of the expansion chamber is shaped so that the inlet is wider than the exhaust pipe from the engine/muffler. The exhaust pipe from the engine/muffler in put in the inlet of the expansion chamber. This means that there is a small space between the outside surface of the exhaust pipe and the edges of the inlet in the expansion chamber. When the engine is running and the exhaust gas from the engine is lead into the expansion chamber will air from the inside of the cover be sucked through the small space between the outside surface of the exhaust pipe and the edges of the inlet in the expansion chamber and into the expansion chamber. The air from inside the cover will mix with the high temperature exhaust gas in the expansion chamber, which will lower the temperature of the air mixture before they continue out through the outlet of the expansion chamber.

The cover can due to the insulation of the expansion chamber be made of a material with low weight that not has to be resistible to high temperatures. This is favourable both for the noise level generated by the tool, the total weight of the tool and the manufacturing of the tool.

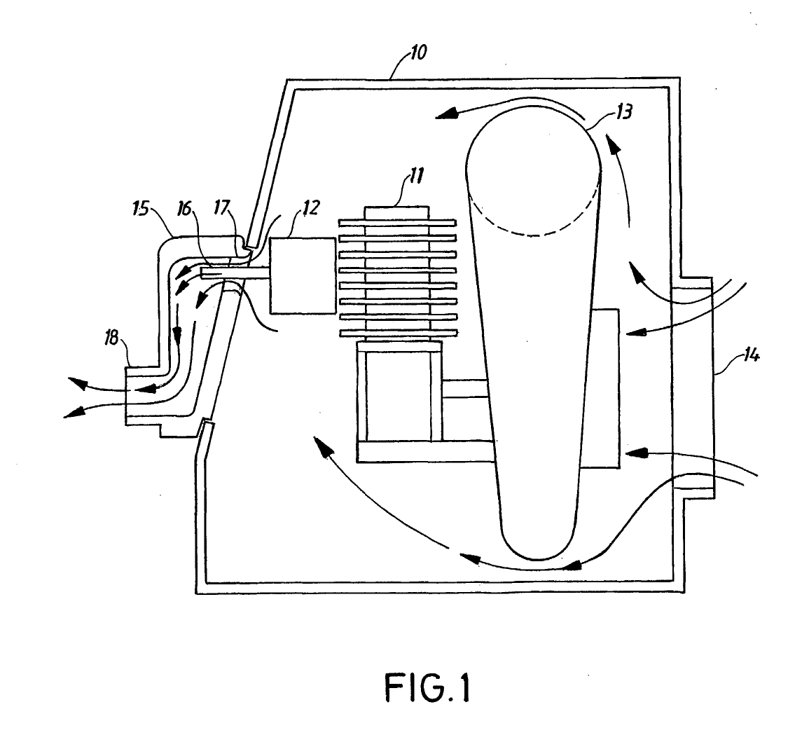

FIG. 1: Illustrates a vertical cross section through a first embodiment of the invention where exhaust gas is lead through cover by an expansion chamber.

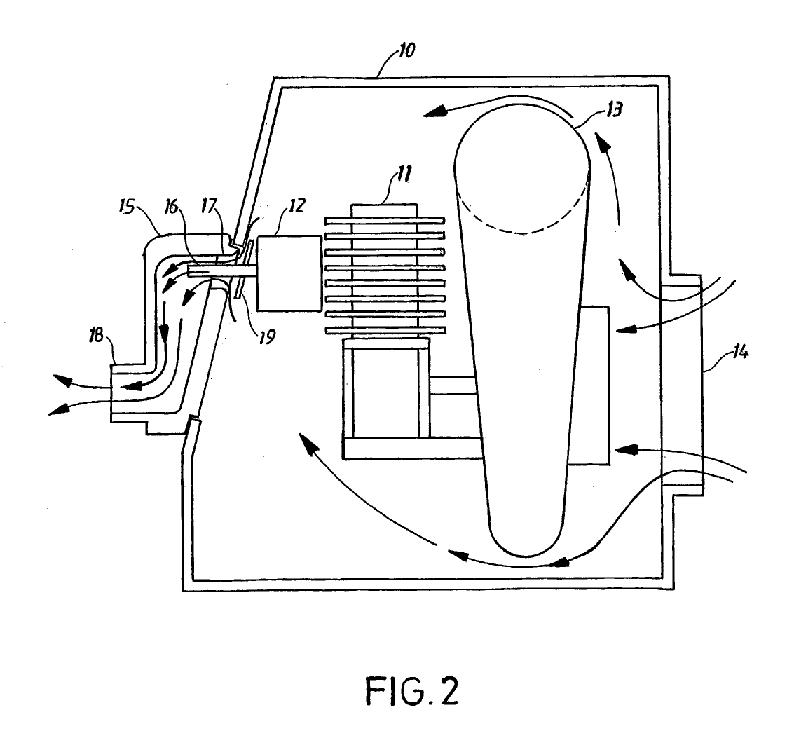

FIG. 2: Illustrates a vertical cross section through a second embodiment of the claimed invention.

A portable leaf blower carried on the back of the operator according to the invention includes an engine 11, a muffler 12 and a fan 13 all placed inside a noise insulating cover 10. The cover 10 that also is the chassis for an non-illustrated device for the carrying of the tool is provided with an air inlet 14 placed on the side of the tool that is turned towards the back of the operator during normal use.

The cover 10 comprises the expansion chamber 15 that is placed so that an exhaust pipe 16 from the muffler 12 is located in an inlet 17 to the expansion chamber 15. The cross section of the inlet 17 has a bigger area than the cross section of the exhaust pipe 16 so that there is a distance between the edge of the inlet 17 and the surface of the exhaust pipe 16. This distance results in that air from the inside of the cover 11 will be sucked into the expansion chamber 15 where it will be mixed with the exhaust gas from the muffler 12. The mixture of air from the inside of the cover 11 and the exhaust gas from the muffler 12 will then leave the expansion chamber 15 via an outlet 18. The expansion chamber 15 is preferably made of a ceramic material that provides good insulation to both high temperatures and noise while the cover 11 preferably is made of a plastic material. The expansion chamber 15 is S-shaped to stop the sound waves from passing through the expansion chamber 15 and continue out into the environment.

If the expansion chamber 15 is used for a tool where it is a negative pressure in the air inside the insulating cover 11 is the exhaust pipe 16 from the muffler 12 preferably provided with a plate 19 that at least partially covers the inlet 17 to the expansion chamber 15. The plate 19 is used in order to crate a force into the expansion chamber 15 that exceeds the negative pressure inside the cover 11 to prevent the exhaust gas from the muffler 12 to be sucked inside the cover 11 instead of into the expansion chamber 15 and continue out to the environment. The plate 19 is preferably placed so that it not is in contact with the surface of the inlet 17 to the expansion chamber 15 to reduce the amount of vibrations and heat that is transferred from the exhaust pipe 16 and the plate 19 to the expansion chamber 15 and the cover 11. The size and exact position of the plate 19 in relation to the inlet 17 of the expansion chamber 15 is selected so that the space between the plate 19 and the inlet 17 gives a force of enough strength into the expansion chamber 15. Air is then sucked from the inside of the cover 11 into the expansion chamber 15.

1. Device for noise and/or heat insulation of a exhaust gas outlet on a portable engine-powered tool with a cover (10) that surrounds the engine (11) or other noise generating parts, characterised in that the exhaust gas is lead through the cover (11) via an expansion chamber (15).

2. Device according to claim 1, characterised in that the expansion chamber (15) is made of a heat insulating material.

3. Device according to claim 1 or 2, characterised in that the expansion chamber (15) is made of a ceramic material.

4. Device according to any of the previous claims, characterised in that the expansion chamber (15) is made of a sound insulating material.

5. Device according any of the previous claims, characterised in that the expansion chamber (15) has an inlet (17) with a cross section that is bigger than the cross section of an exhaust pipe (16) from the engine (11) so that air from the inside of the cover (10) is sucked into the expansion chamber (15) and mixed with the exhaust gas in the expansion chamber (15).

6. Device according to claim 5, characterised in that the exhaust pipe (16) is surrounded by a plate (19) for adjustment of the space between the exhaust pipe (16) and the inlet (17) to the expansion chamber (15).

7. Device according to any of previous claims, characterised in that the exhaust gas is lead through the expansion chamber (15) in a curved direction.

8. Device according to claim 7, characterised in that the expansion chamber (15) is S-shaped.

9. Device according to any of previous claims, characterised in that the expansion chamber (15) is integrated in the cover (10).
